(19) United States
(12) Patent Application Publication
(10) Pub. No.: US 2013/0033102 A1
(43) Pub. Date: Feb. 7, 2013

(54) EMBEDDED BATTERY MANAGEMENT SYSTEM AND METHODS

(71) Applicants: Lonnie Calvin Goff, Tempe, AZ (US); Mark Edmond Eidson, Tempe, AZ (US); Michael Richard Conley, Thousand Oaks, CA (US)

(72) Inventors: Lonnie Calvin Goff, Tempe, AZ (US); Mark Edmond Eidson, Tempe, AZ (US); Michael Richard Conley, Thousand Oaks, CA (US)

(21) Appl. No.: 13/649,881

(22) Filed: Oct. 11, 2012

Related U.S. Application Data
(63) Continuation-in-part of application No. 12/655,275, filed on Dec. 28, 2009.
Application No. 12/655,275 is a continuation-in-part of application No. 12/321,310, filed on Jan. 15, 2009.
Application No. 12/321,310 is a continuation-in-part of application No. 12/380,236, filed on Feb. 25, 2009.
Application No. 12/380,236 is a continuation-in-part of application No. 12/454,454, filed on May 18, 2009, now abandoned.
Application No. 12/454,454 is a continuation-in-part of application No. 13/272,905, filed on Oct. 13, 2011.
Application No. 13/272,905 is a continuation-in-part of application No. 12/075,212, filed on Mar. 10, 2008.
Application No. 12/075,212 is a continuation-in-part of application No. 12/319,544, filed on Jan. 8, 2009.
Application No. 12/319,544 is a continuation-in-part of application No. 12/070,793, filed on Feb. 20, 2008.
(60) Provisional application No. 61/545,847, filed on Oct. 11, 2011.
(60) Provisional application No. 61/592,967, filed on Jan. 31, 2012.

(51) Int. Cl. H02J 7/00; B60L 1/00

(52) U.S. Cl. 307/10.6; 320/134

(57) ABSTRACT

A battery with an embedded battery management system is disclosed. The battery management system facilitates various advantages including monitoring the operational characteristics of individual battery cells, performing passive and/or active cell balancing, calculating the remaining life of the battery, and providing a warning if the battery is near the end of its life. The embedded battery management system also facilitates making battery parameters available externally, interfacing with smart charging systems, and enabling the battery management system to control the smart charging system, for example by making desired charge requests. The embedded battery management system includes non-volatile memory that stores algorithms for implementing different functions of the battery management system.

### CROSS-REFERENCE TO RELATED APPLICATIONS

This application is a continuation-in-part of co-pending U.S. patent application Ser. No. 12/655,275, filed on Dec. 28, 2009 and having at least one common inventor, which is incorporated by reference herein in its entirety.

This application is also a continuation-in-part of co-pending U.S. patent application Ser. No. 12/321,310, filed on Jan. 15, 2009 and having at least one common inventor, which is incorporated by reference herein in its entirety.

This application is also a continuation-in-part of co-pending U.S. patent application Ser. No. 12/380,236, filed on Feb. 25, 2009 and having at least one common inventor, which is incorporated by reference herein in its entirety.

This application is also a continuation-in-part of co-pending U.S. patent application Ser. No. 12/454,454, filed on May 18, 2009 and having at least one common inventor, which is incorporated by reference herein in its entirety.

This application is also a continuation-in-part of co-pending U.S. patent application Ser. No. 13/272,905, filed Oct. 13, 2011 by at least one common inventor, which is a continuation-in-part of each of U.S. patent application Ser. No. 12/075,212, filed Mar. 10, 2008 by at least one common inventor, U.S. patent application Ser. No. 12/319,544, filed Jan. 8, 2009 by at least one common inventor, and U.S. patent application Ser. No. 12/070,793, filed Feb. 20, 2008 by at least one common inventor, each of which is incorporated by reference herein in its entirety.

This application also claims the benefit of co-pending U.S. Provisional Patent Application Ser. No. 61/545,847, filed on Oct. 11, 2011 and having at least one common inventor, which is incorporated by reference herein in its entirety.

This application also claims the benefit of co-pending U.S. Provisional Patent Application Ser. No. 61/592,967, filed on Jan. 31, 2012 and having at least one common inventor, which is incorporated by reference herein in its entirety.

### BACKGROUND OF THE INVENTION

1. Field of the Invention

The present invention relates to the field of batteries, particularly lead-acid batteries. Even more particularly, the invention relates to batteries having embedded computer systems and methods that measure internal operating characteristics of multi-cell batteries and make information available externally, for example to an external charging system or to warn that the battery is approaching the end of its life. The invention also particularly relates to performing active and/or passive cell balancing within the battery, optionally in conjunction with an external intelligent charging system.

2. Description of the Background Art

All batteries fail. Battery failure is the number one complaint of new car owners. Batteries typically fail unexpectedly without warning, which is undesirable.

Automobile manufactures typically provide only the real-time state of the car's charging system (alternator) when the engine is running The battery is only one component of this system. This system warns the motorist when there is a problem with the charging system by using a dash mounted voltmeter, ammeter or more commonly a warning lamp which is often referred to as the “idiot light”. This information should not be confused nor equated with the operating state or the overall health of the battery, itself.

The typical automobile lead-acid starter battery consists of six electrochemical cells embedded in a polymer case. Because the cells are encased, cell voltage measurements cannot be taken, the temperature or pressure inside the battery is not known, and for those batteries without filler caps the level of the electrolyte cannot be determined. Generally, the internal operating characteristics of the individual cells of the battery, and the battery itself, are unknown.

The single most prevalent cause of lead-acid battery failure is incorrect battery charging. Overcharging causes grid corrosion. Undercharging causes battery sulfation. Both lead to premature battery failure. Unfortunately, charging systems in today's automobiles are blind devices, in that they do not know the internal operating characteristics (e.g., voltage, pressure, temperature, specific gravity, electrolyte level, etc.) of the battery, much less the operating characteristics of the individual cells of the battery. None of today's vehicular batteries provide the information required by charging systems to perform optimal charging.

Moreover, when the voltages of individual cells inside a lead-acid battery differ by as little as one one-hundredth of a volt, the health of the battery is in jeopardy. An imbalance causes weaker cells to become progressively undercharged and the stronger cells to suffer the consequences of being consistently overcharged. Unless this imbalance can be quickly ameliorated the battery will prematurely fail.

Cell balance is typically restored in lead-acid batteries by passive equalization whereby temporarily overcharging the battery at a voltage of 14.4 volts for 15 minutes is used in an attempt to bring weak cells into alignment. This approach is a risky proposition. The external charging system does not know the voltage of each individual cell, so it does not know if or when to apply a cell balancing routine nor will it know if the cell balancing attempt was successful. The external charging system also does not know the level of the electrolyte of each cell or the internal temperature and pressure of the battery. If the strong cells are excessively overcharged, their positive plates will disintegrate or buckle and the excessive temperature generated in the cell by overcharging will cause loss of electrolyte. On the other hand, if the weak cells are not sufficiently charged, the cell imbalance will remain and the battery will die prematurely.

### SUMMARY

The present invention overcomes the problems associated with the prior art by providing a battery with an embedded computer system. The computer system is capable of, among other things, measuring operating parameters of the battery (individual cell voltages, the electrolyte level of each cell, internal temperature, internal pressure, etc.) and providing this sensor information externally if desired via an external interface. The computer system also is capable of measuring time and includes memory for storing a data history, as well as various battery management algorithms. The algorithms can render an optimal charging voltage or charging current for the battery based upon its internal sensor data, and communicate the optimal charging information to an external smart charging system. The algorithms can use the sensor data and sensor history to detect alarm conditions that indicate the imminent failure of the battery. The computer system may also include facilities for shunting current around individual cells or for transferring energy from strong cells to weak cells using, for example, magnetic components or capacitors.

The present invention also provides the ability to first detect a cell imbalance inside the lead-acid battery and then to carefully control the process by which the imbalance is ameliorated. The present invention makes use of a computer system that can detect such an imbalance. Once detected, a closed loop control path is established with an external intelligent charging system. Different charge requests are made of the intelligent charger. All the while the battery's internal state is carefully monitored to avoid permanent damage.

This invention can also be properly viewed as a research tool. There is a multitude of things that can cause a cell imbalance. Some examples are partial shorts between positive and negative plates, partial shorts between plates and straps, improper electrolytic levels, crystallized lead sulfate accumulations and incorrect specific gravity. This invention is heuristic in nature in that there is no established methodology that correlates or matches charging schemes to the underlying cause of a cell imbalance. A charging regime is tried by a cell balancing algorithm and its results are monitored. If the cell imbalance persists a different cell balancing algorithm is tried. This next charging regime may be similar to the previous attempt or may be radically different depending upon any detectable improvements. If no improvement occurred, the next charging regime will depart from the previous. The internal state of the battery continues to be monitored to insure no harm is being done. When a successful result is determined the successful technique is saved in a history file. This history is made readily available over the communication path normally established between battery and battery charging system. If the underlying cause of the imbalance is not apparent, such as plate sulfation, a post mortem can be performed on the battery in order to more properly correlate successful cell balancing techniques to the root cause of the imbalance. With this information battery manufacturers will have better insight into the failure mechanisms of their batteries while automobile and battery charger manufacturers will be able to build better charging systems.

Depending upon the facilities and the makeup of the embedded computer system and its ability to control the external charging system, either passive, active or a combination of the two equalization schemes can be used to fix cell imbalances inside a multi-cell enclosed battery such as a lead-acid starter battery.

For passive equalization schemes, the embedded computer system establishes a closed-loop control path with an external intelligent charging system. Different charge requests are made of the intelligent charger. All the while the battery's internal state is carefully monitored to avoid damage. A cell balancing algorithm can be made to mimic the typical 14.4 volt flat charge rate of 15 minutes that is performed by many of today's open-loop battery chargers. A different cell balancing algorithm can be made to issue a much higher voltage request for a much shorter period of time. Still other algorithms can issue cyclic voltage requests that create pulse charging. At the termination of each algorithm a check is made to see if the cells have been brought back into balance. If not, a different algorithm may be attempted.

For active equalization schemes the embedded computer system, depending upon the embedded computer systems hardware facilities, can perform power switching or dissipative load switching. Dissipative load switching involves temporarily activating resistive loads across individual cells in order to shunt current away from saturated cells. Power switching involves the transfer of energy from strong cells to weak cells using magnetic components or capacitors.

According to yet another embodiment of the invention, the remaining life of a battery can be determined, and a warning can be generated when the battery is nearing the end of its life. According to the invention, a computer system embedded inside the battery includes facilities for measuring time and temperature, includes storage facilities for retaining a history of these measurements, knowledge of the age of the battery, and optionally, empirical data about the effect of temperature on battery lifespan. In addition, the computer system includes algorithms for predicting the remaining life of the battery based upon time and temperature measurements, the current age of the battery, and optionally the empirical data. Finally the computer system includes means to communicate to the outside world, for example, the operator of a vehicle, by using a low power wireless technology such as Bluetooth Low Energy which is a feature of Bluetooth 4.0.

### BRIEF DESCRIPTION OF THE DRAWINGS

The present invention is described with reference to the following drawings, wherein like reference numbers denote substantially similar elements:

FIG. 1 is a block diagram of a computer-based system shown embedded inside a flooded lead-acid battery that has six internal cells. This computer system includes a means for measuring cell voltages, cell electrolytic levels and battery temperature. The computer system includes a means to communicate with an external battery charging system. The computer system includes a means to execute algorithms that perform cell balancing by issuing charge request messages to an external charger.

FIG. 1A is a flow chart illustrating the steps taken by one embodiment of the cell balancing computer program of this invention when it is executed by the computer system of FIG. 1.

FIG. 2 is a block diagram of a computer-based system shown embedded inside a sealed lead-acid battery that has six internal cells. This computer system includes a means for measuring cell voltages, pressure and battery temperature. The computer system includes a means to communicate with an external battery charging system. The computer system includes a means to execute algorithms that perform cell balancing by issuing charge request messages to an external charger.

FIG. 2A is a flow chart illustrating the steps taken by another embodiment of the cell balancing computer program of this invention when it is executed by the computer system of FIG. 2.

FIG. 3 is a block diagram of a computer-based system shown embedded inside a flooded lead-acid battery that has six internal cells. This computer system includes a means for measuring cell voltages, internal battery current and a means for performing active equalization of the battery's internal cells. The computer system includes a means to execute algorithms that perform active cell equalization using the active equalizer subsystem.

FIG. 3A is a block diagram of the active equalizer subsystem. This subsystem, under the control of the computer system of FIG. 3, can cause some of the energy destined to charge an individual cell to be diverted into a dissipative load circuit and thereby mitigate cell overcharging.

FIG. 3B is a flow chart illustrating the steps taken by one embodiment of the cell balancing active equalization computer program of this invention when it is executed by the computer system of FIG. 3.

FIG. 4 is a block diagram of a computer system according to an embodiment of the invention that is embedded inside a lead-acid battery, calculates the remaining life of the battery based upon its operating temperatures and current age and makes this information available to a remote operator.

FIG. 5 is a flow chart illustrating the steps taken by the structural illustration of FIG. 4 when it collects battery temperature data, calculates the remaining life of the battery and transfers this information.

FIG. 6 is a block diagram of a computer system according to another embodiment of the invention that is embedded inside a lead-acid battery, calculates the remaining life of the battery based upon its operating temperatures and date of manufacture and makes this information available to a remote operator.

FIG. 7 is a flow chart illustrating the steps taken by the structural illustration of FIG. 6 when it collects battery temperature data, calculates the remaining life of the battery and transfers this information to the remote operator.

FIG. 8 is a block diagram of a computer system embedded within a battery according to still another embodiment of the invention.

### DETAILED DESCRIPTION

The following descriptions are provided to enable any person skilled in the art to make and use the invention and are provided in the context of the particular embodiments. Various modifications to these embodiments are possible and the generic principles defined herein may be applied to these and other embodiments without departing from the spirit and scope of the invention. The embodiments described herein perform their intended functions using a computer system embedded inside a lead-acid battery. Special notification is made with regard to battery technology. While the present invention is particularly well-suited to lead-acid batteries, the generic principles described herein apply to any battery type. Thus the invention is not intended to be limited to the embodiments shown but is to be accorded the widest scope consistent with the principles, features and teachings disclosed herein.

In accordance with one embodiment, the present invention makes use of a computer system that resides inside a flooded lead-acid battery. The computer system includes a means to measure individual cell voltages, the level of the electrolyte in each cell and the internal temperature of the battery. The computer system includes a means to communicate with an external battery charging system through the power cable attached to the battery. The computer system's central processing unit includes a means to measure time and includes facilities for storing data. The computer system's non-volatile memory includes algorithms that have a means to detect cell imbalances and to perform cell balancing by sending charge request messages to an external charging system.

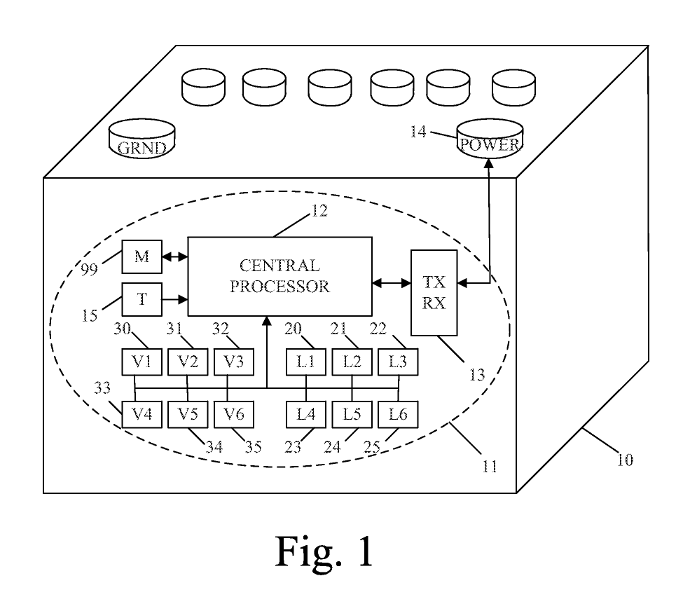

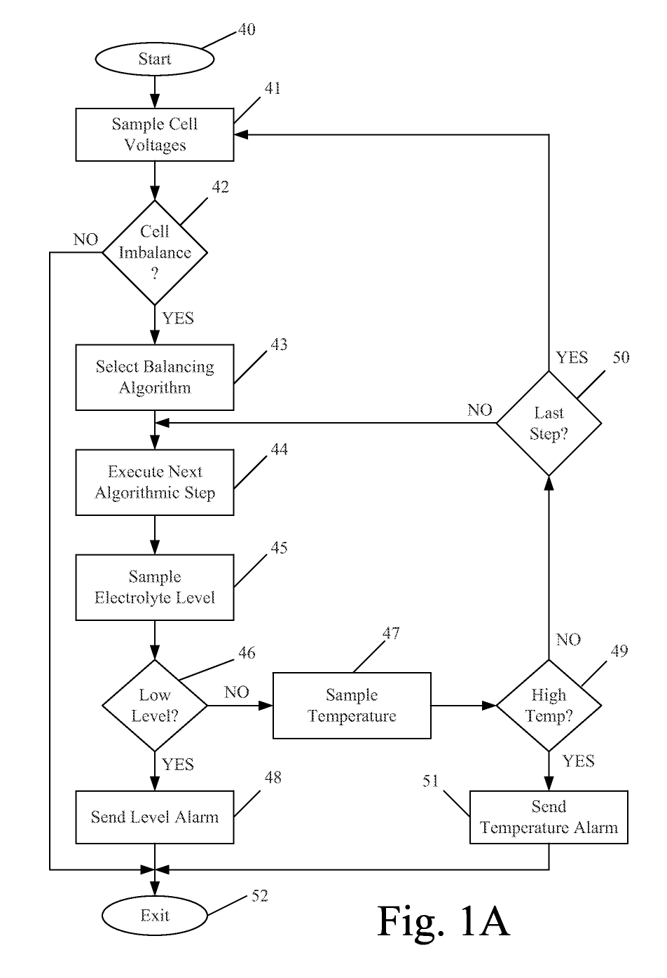

FIG. 1 is a block diagram illustrating computer system 11 shown embedded inside flooded lead-acid battery 10. Computer system 11 includes a data path to power connector 14 through transceiver 13. Transceiver 13 is used to transfer information between central processor 12 and one or more external devices (not shown) attached conductively to power connector 14. Sensors 30-35 measure individual cell voltages and pass this information to central processor 12. Sensors 20-25 provide the level of the electrolyte in each of the battery's cells and pass this information to central processor 12. Temperature sensor 15 measures the temperature inside the battery's case and passes this information to central processor 12. Computer system 11 includes a non-volatile memory 99 that stores the cell-balancing algorithms.

FIG. 1A is a flowchart illustrating those steps taken by a cell balancing program when executed by central processor unit 12 of FIG. 1 in order to detect and correct a cell voltage imbalance in battery 10 of FIG. 1. Execution of the cell-balancing program is initiated at step 40 of FIG. 1A by central processor 12 of FIG. 1. In step 41 of FIG. 1A the voltage of each cell is sampled by central processor unit 12 of FIG. 1 using voltage sensors 30-35 of FIG. 1. At step 42 of FIG. 1A a comparison is made between individual cell voltages and program control transfers to either step 43 if an imbalance is detected or, if not, to step 52 where the cell balancing program is exited. At step 43 of FIG. 1A, a cell balancing algorithm is selected from a number of possible algorithms. This selection is based on factors that include the extent of the imbalance, the age of the battery, the temperature of the battery and the level of the electrolytes. At step 44 of FIG. 1A the first step of the algorithm is executed. The first step causes central processor 12 of FIG. 1 to send a charge request message to the external charging system attached to the power cable (not shown) through transceiver 13 and power connector 14 of FIG. 1. This, in turn, causes the voltage requested in the charge request message to be applied to battery 10 of FIG. 1 by the external charging system (not shown). Program control then proceeds to step 45 of FIG. 1A where the level of the electrolyte of each individual cell is sampled by central processor 12 of FIG. 1 using the electrolytic level sensors 20-25 of FIG. 1. At step 46 of FIG. 1A program control transfers to either step 48 of FIG. 1A if the electrolytic level of any cell is too low for the cell balancing algorithm to continue or to step 47 if all the electrolytic levels are good. If program control transferred to step 48, central processor 12 of FIG. 1 will send an alarm message across the power cable (not shown) using transceiver 13 of FIG. 1. Program control then passes to step 52 where the cell balancing program is exited. If program control transferred to step 47 of FIG. 1A the temperature sensor 15 of FIG. 1 is sampled and program control proceeds to step 49. Step 49 causes program control to transfer to either step 51 of FIG. 1A if the battery's temperature is too high for the cell balancing algorithm to continue or, if not, to step 50. At step 51, central processor 12 of FIG. 1 sends a temperature alarm message across the power cable (not shown) attached to power connector 14 of FIG. 1 and program control passes to step 52 where the cell balancing program is exited. If the temperature of the battery as read at step 47 of FIG. 1A is not excessive, step 49 of FIG. 1A causes program control to pass to step 50 of FIG. 1A. At step 50 a check is made to see if the last step of the cell balancing algorithm has been executed. If the last step has not been executed, program control returns to step 44 where the next step of the cell balancing algorithm is executed and the balancing algorithm repeats. If the check at step 50 of FIG. 1A determines that the algorithm has finished, program control proceeds to step 41 of FIG. 1A and the cell balancing program repeats.

In accordance with another embodiment, the present invention makes use of a computer system that resides inside a sealed lead-acid battery. The computer system includes a means to measure individual cell voltages, the internal pressure of the battery and the internal temperature of the battery. The computer system includes a means to communicate with an external battery charging system through the power cable attached to the battery. The computer system's central processing unit includes a means to measure time and includes facilities for storing data. The computer system's non-volatile memory includes algorithms that have a means to detect cell imbalances and to perform cell balancing by sending charge request messages to an external charging system.

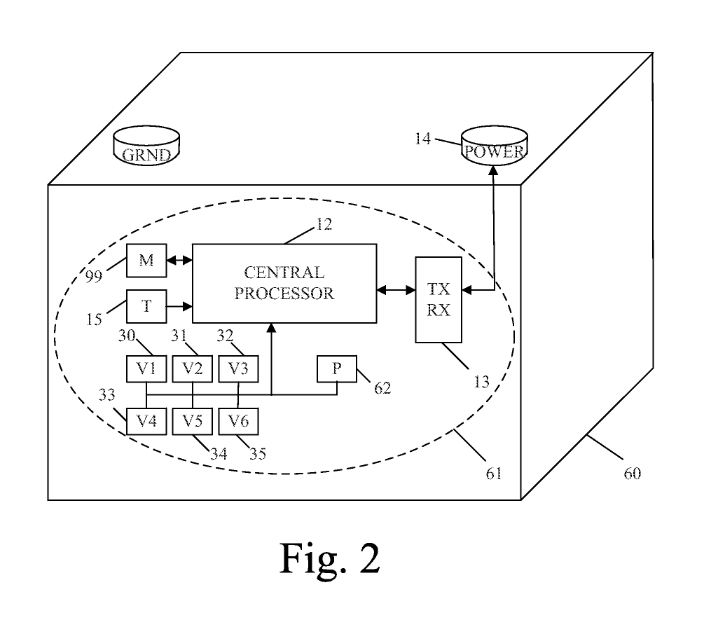

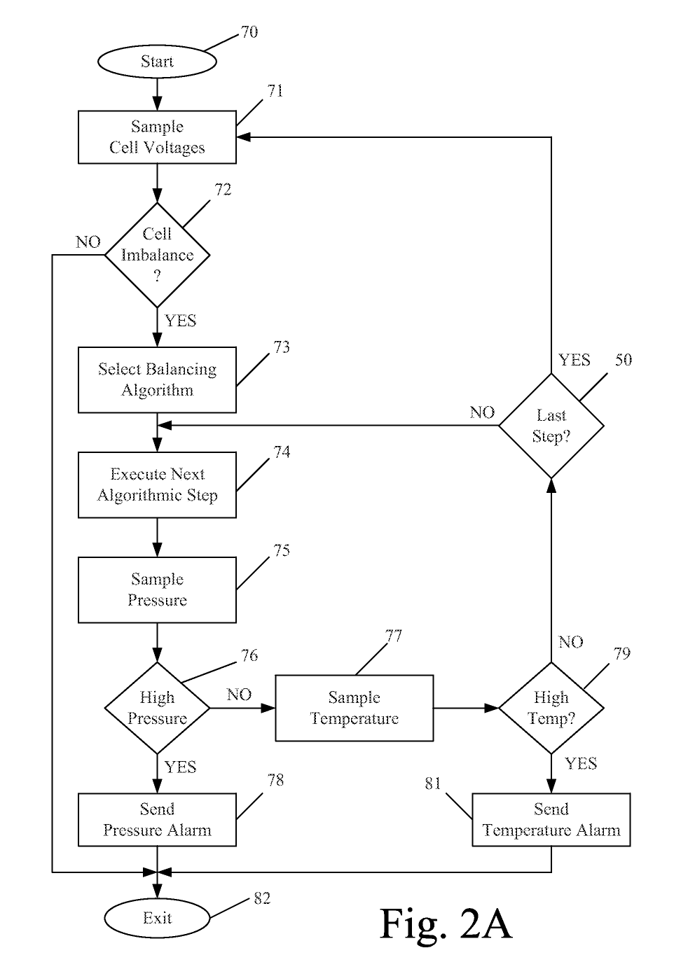

FIG. 2 is a block diagram illustrating computer system 61 shown embedded inside sealed lead-acid battery 60. Computer system 61 includes a data path to power connector 14 through transceiver 13. Transceiver 13 is used to transfer information between central processor 12 and one or more external devices (not shown) attached conductively to power connector 14. Sensors 30-35 measure individual cell voltages and pass this information to central processor 12. Pressure sensor 62 measures the pressure inside the sealed battery and passes this information to central processor 12. Temperature sensor 15 measures the temperature inside the battery's case and passes this information to central processor 12. Computer system 61 includes a non-volatile memory 99 that stores the cell-balancing algorithms.

FIG. 2A is a flowchart illustrating those steps taken by a cell balancing program when executed by central processor unit 12 of FIG. 2 in order to detect and correct a cell voltage imbalance in battery 60 of FIG. 2. Execution of the cell- balancing program is initiated at step 70 of FIG. 2A by central processor 12 of FIG. 2. In step 71 of FIG. 2A the voltage of each cell is sampled by central processor unit 12 of FIG. 2 using voltage sensors 30-35 of FIG. 2. At step 72 of FIG. 2A a comparison is made between individual cell voltages and program control transfers to either step 73 if an imbalance is detected or, if not, to step 82 where the cell balancing program is exited. At step 73 of FIG. 2A a cell balancing algorithm is selected from a number of possible algorithms. This selection is based on factors that include the extent of the imbalance, the age of the battery, the temperature of the battery and the level of the electrolytes. At step 74 of FIG. 2A the first step of the algorithm is executed. The first step causes central processor 12 of FIG. 2 to send a charge request message to the external charging system attached to the power cable (not shown) through transceiver 13 and power connector 14 of FIG. 2. This, in turn, causes the voltage requested in the charge request message to be applied to battery 60 of FIG. 2 by the external charging system (not shown). Program control then proceeds to step 75 of FIG. 2A where the internal pressure of the battery is sampled by central processor 12 of FIG. 2 using the pressure sensor 62 of FIG. 2. At step 76 of FIG. 2A program control transfers to either step 78 of FIG. 2A if the battery's pressure is too high for the cell balancing algorithm to continue or to step 77 if the pressure is not excessive. If program control transferred to step 78, central processor 12 of FIG. 2 will send a pressure alarm message across the power cable (not shown) using transceiver 13 of FIG. 2. Program control then passes to step 82 where the cell balancing program is exited. If program control transferred to step 77 of FIG. 2A the temperature sensor 15 of FIG. 2 is sampled and program control proceeds to step 79. Step 79 causes program control to transfer to either step 81 of FIG. 2A if the battery's temperature is too high for the cell balancing algorithm to continue or, if not, to step 80. At step 81 central processor 12 of FIG. 2 sends a temperature alarm message across the power cable (not shown) attached to power connector 14 of FIG. 2 and program control then passes to step 82 where the cell balancing program is exited. If the temperature of the battery as read at step 77 of FIG. 2A is not excessive, step 79 of FIG. 2A causes program control to pass to step 80 of FIG. 2A. At step 80 a check is made to see if the last step of the cell balancing algorithm has been executed. If the last step has not been executed, program control returns to step 74 where the next step of the cell balancing algorithm is executed and the balancing algorithm repeats. If the check at step 80 of FIG. 2A determines that the algorithm has finished, program control proceeds to step 71 of FIG. 2A and the cell balancing program repeats.

In accordance with yet another embodiment, the present invention makes use of a computer system that resides inside a sealed lead-acid battery. The computer system includes a means to measure individual cell voltages and internal battery current and includes the means to perform active cell equalization using dissipative load switching. The computer system may optionally include a means to communicate with an external battery charging system through the power cable attached to the battery but this means is not essential in the performance of active equalization and is not included in this embodiment. The computer system's central processing unit includes a means to measure time and includes facilities for storing data. The computer system's non-volatile memory includes algorithms that have a means to detect cell imbalances and to perform active cell equalization by communicating with the active cell equalizer subsystem.

Active equalization includes dissipative load switching and power switching. Dissipative load switching involves temporarily switching resistive loads across saturated cells. Power switching involves the transfer of energy from strong cells to weak cells using magnetic components or capacitors. Until now, neither of these techniques could be used for lead-acid batteries because the individual cell voltages were unknowable and the means to actively equalize cells encased in a battery did not exist.

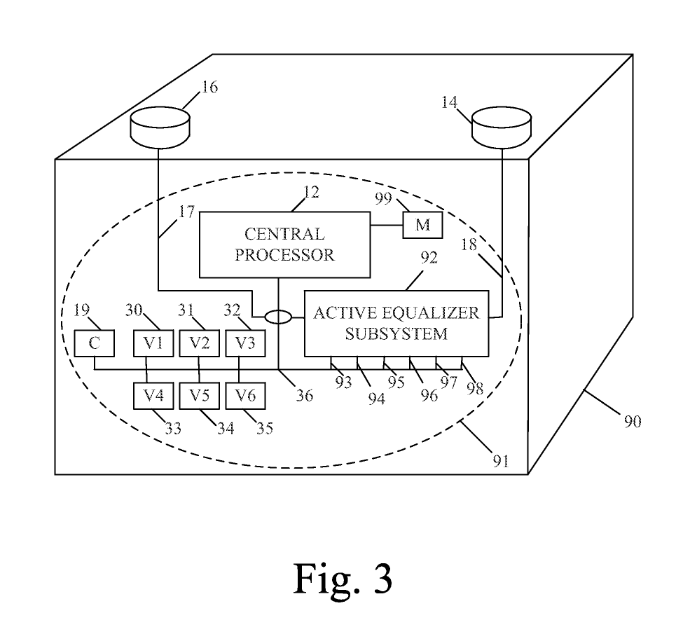

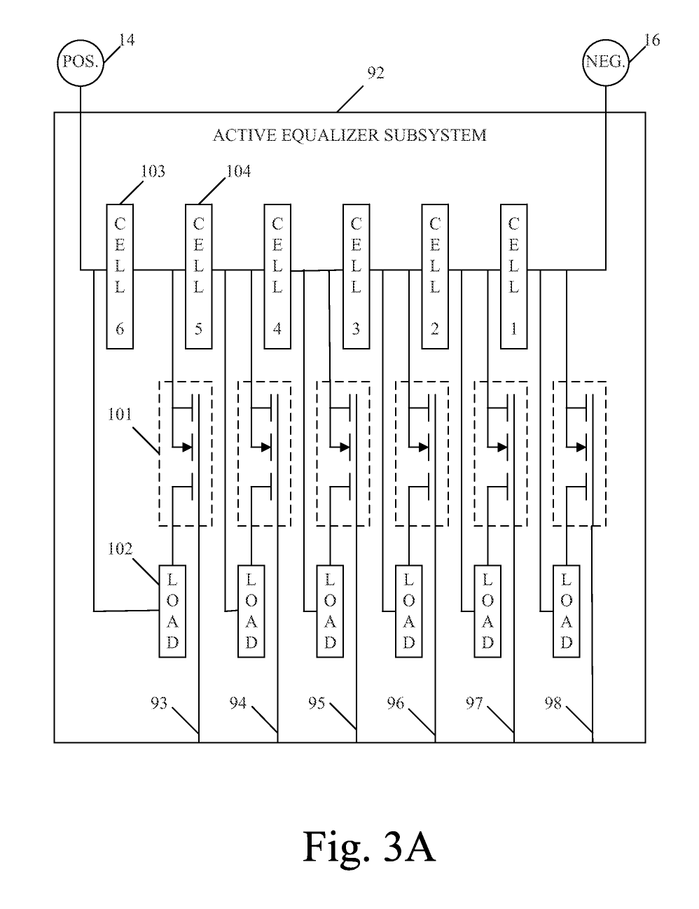

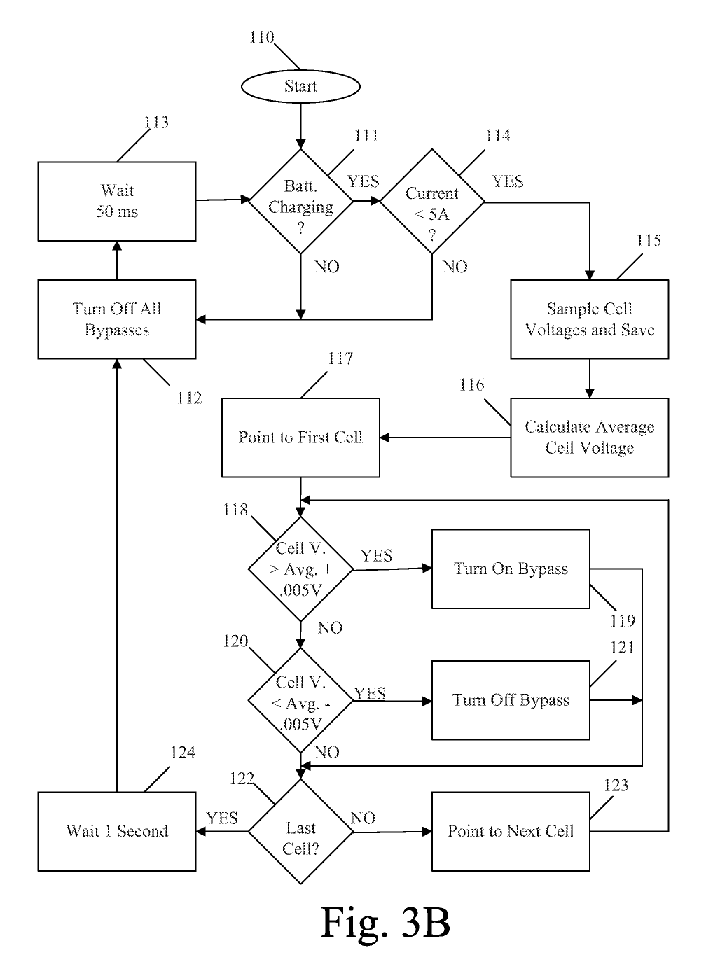

FIG. 3 is a block diagram illustrating computer system 91 shown embedded inside sealed lead-acid battery 90. Sensors 30-35 measure individual cell voltages and pass this information across bus 36 to central processor 12. Active cell equalizer subsystem 92 is controlled by central processor 12 across bus 36 which includes separate control signals 93-98 for each individual cell. Active equalizer subsystem 92 internally makes electrical connection to battery ground terminal 16 and battery power terminal 14 through connector paths 17 and 18 respectively. Computer system 91 includes a non-volatile memory 99 that stores the active-equalization, cell-balancing algorithms.

FIG. 3A is a block diagram of the active equalizer subsystem 92 that was initially shown in FIG. 3. Control signal 93 from central processor 12 of FIG. 3 interfaces to the bypass FET switch 101 which, when enabled, will divert some of the charging current from Cell 5 104 into dissipative load 102 thereby reducing the amount of energy coupled into Cell 6 103. Calculations show that a dissipative load of 100 ohms will result, when enabled, in an approximate 0.4% reduction in the energy applied to a relatively overcharged cell which in turn is equivalent to approximately 0.01V. In like manner control signals 94-98 are used to control the charging current in the other 5 battery cells.

FIG. 3B is a flowchart illustrating those steps taken by an active equalization cell balancing program when executed by computer system 91 of FIG. 3 in order to detect and correct a cell voltage imbalance in battery 90 of FIG. 3. Execution of the cell- balancing program is initiated at step 110 of FIG. 3B by central processor 12 of FIG. 3. At step 111 of FIG. 3B the battery's internal current is sampled by central process 12 of FIG. 3 using current sensor 19 of FIG. 3. If the current reading indicates that the battery is not being charged, program control proceeds to step 112 whereby all bypasses remain off and the cell balancing program resumes at step 111 after a short delay at step 113. If, on the other hand, the battery is being charged by an external device such as a car's alternator system or an external battery charger, program control proceeds to step 114 where the charge current is compared to a fixed value of 5 amps. As lead-acid batteries approach their fully charged state their current demand drops down into the 2 to 5 amp range. With a 100 ohm resistor used for the load as represented by 102 in FIG. 3A, 5 amps is a good threshold for a dissipative load switch because the power loss across 102 in FIG. 3A will never exceed an approximate 0.05W when load switching is prevented above the 5 amp limit. If the charge current is below the 5 amp threshold, program control proceeds to step 115. At this step, all of the cell's voltages are sampled and saved by computer system 91 of FIG. 3 using voltage sensors 30-35. At step 116 the average of all of the cell voltages is calculated and saved. At step 117 the first of the saved cell voltages, as saved in memory, is pointed to. At step 118 the pointed to cell voltage is retrieved and compared to the average cell voltage plus an additional 0.005V. Research has shown that a cell imbalance as small as 0.01V will cause a string of cells to prematurely fail. The goal of this particular algorithm is to maintain all cell voltages within this 0.01V range. If the cell's voltage is 0.005V above the average cell voltage, program control proceeds to step 119 where the charge current flowing into this relatively overcharged cell will be reduced by computer system 91 of FIG. 3 by turning on the appropriate Active Equalizer Subsystem control signal 93-98 as shown in both FIG. 3 and FIG. 3A wherein the appropriate FET, such as 101 for cell 6, is energized and causes bypass current to flow. If, however, at step 118, the cell voltage does not exceed the upper limit set by the average cell voltage plus 0.005V, program control proceeds to step 120. At step 120 the cell voltage is compared to the average cell voltage minus 0.005V and if it is below this threshold, program control proceeds to step 121 where the bypass current switch is disabled by computer system 91 of FIG. 3 by turning off the appropriate Active Equalizer Subsystem control signal 93-98 as shown in both FIG. 3 and FIG. 3A wherein the appropriate FET, such as 101 for cell 6, is de-energized and causes any previously enabled bypass current to stop flowing. At step 122 a check is made to determine if all six cells have been processed. If more cells remain to be processed, program control proceeds to step 123 where the next cell in the list of saved cell voltages is pointed to and program control returns to step 118 and the program repeats. If, on the other hand, all the cells have been processed, program control passes from step 122 to step 124. At step 124, no action is taken for 1 second in order to permit time for the equalized battery paths to carry charge current. After 1 second program control proceeds to step 112 where all current bypasses are turned off by computer system 91 using control signals 93-98 of FIG. 3A. At the next step, 113, a 50ms delay is executed in order to give the battery time to react to being charged without bypass paths enabled. Program control then returns to step 111 where this program repeats and, assuming the battery is still being charged below 5 amps, all of the cell voltages are sampled once again at step 115 and appropriate bypass path re-adjustments are then made as program execution continues.

This invention changes the age old paradigm whereby the battery charging system blindly controls the procedure by which the cells in a multi-cell battery, such as the ubiquitous twelve volt lead-acid battery, can be kept in balance. With this invention the battery is now in control.

For passive equalization, a closed loop system is established with the charging device. The battery knows when a cell is out of balance. The battery possesses the heuristic means to reduce or remove a cell imbalance by controlling charge applications while monitoring internal sensors to insure that no harm is done. In other words, the battery possesses the means to learn from trial and error which charge strategy works best to reduce or remove cell imbalances.

For active equalization, the battery has the means to individually control the amount of energy applied to individual cells. Highly charged cells receive less energy, weak cells get more. Because this invention is a computer program that executes on a computer system embedded inside a multi-cell battery it has access to the voltage of each individual cell and therefore can detect a cell imbalance. Furthermore, because the embedded computer system includes a means to communicate with an external charging system, the invention has a means to control the amount and duration of charge applied to the battery when a cell balancing operation is in progress. Moreover, because the embedded computer system has access to the internal temperature of the battery, the internal pressure of the battery, the electrolytic levels, and other sensor information, this invention can ensure that the battery is not damaged by the aggressive charging schemes used by cell balancing procedures.

This invention can also be properly viewed as a research tool. There is a multitude of things that can cause a cell imbalance. Some examples are partial shorts between positive and negative plates, partial shorts between plates and straps, improper electrolytic levels, crystallized lead sulfate accumulations and incorrect specific gravity. This invention is heuristic in nature in that there is no established methodology that correlates or matches charging schemes to the underlying cause of a cell imbalance. A charging regime can be tried by a cell balancing algorithm and its results evaluated. If the cell imbalance persists a different cell balancing algorithm may be attempted. This next charging regime may be similar to the previous attempt or may be radically different depending upon detectable improvements. If no improvement occurred, the next charging regime will depart from the previous. The internal state of the battery continues to be monitored to insure no harm is being done. When a successful result is determined the successful technique is saved in a history file. In like manner the algorithms that control power and dissipative load switching can be heuristically modified, tested and evaluated in order to find and save the most effective techniques. This history is made readily available over the communication path normally established between battery and battery charging system. New and improved algorithms can also be downloaded to the embedded processor, tested and evaluated. When the battery eventually fails, as all batteries do, a post mortem can be performed on the battery in order to determine the root cause of the failure. With this type of information battery manufacturers will have better insight into the failure mechanisms of their batteries while automobile and battery charger manufacturers will be able to build improved charging systems.

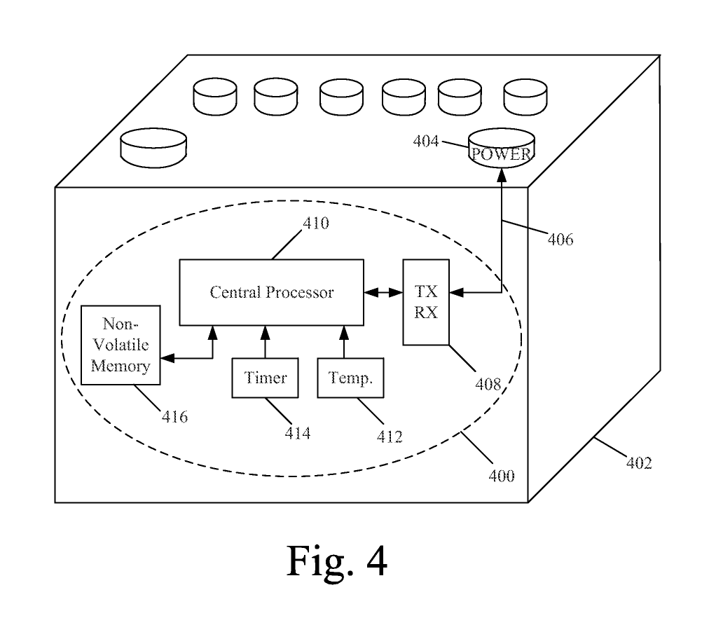

FIG. 4 is a block diagram illustrating a computer system 400 shown embedded inside a battery 402 (e.g., a lead-acid battery). Computer system 400 calculates the remaining life of the battery based upon its operating temperatures and current age and makes this information available to a remote operator.

Computer system 400 includes an electrical connection to battery terminal 404 through conductor 406. Transceiver 408 is used to receive and transmit data between central processor 410 and one or more external devices (not shown) attached to the terminal 404 power cable using the industry standard Local Interconnect Network (LIN) vehicle bus protocol. Temperature sensor 412 measures the temperature of the electrolyte. Timer 414 measures the elapsed time between temperature samples. Central processor 410 also stores the age of the battery 402 in a non-volatile memory 416. For example, the manufacturing date of battery 402 can be stored in memory 416, which can be used to determine the age of the battery 402, for example, based on the difference between the manufacturing date and a current date maintained by central processor unit 410.

The lead-acid battery's lifespan is reduced by half for every 15° F. above its optimal operating temperature of 77° F. The embedded computer system 400 makes use of this knowledge to notify the driver, based upon the length of time in service and operational temperature measurements, that the battery 402 is approaching its predicted end of life. The following equation is used for calculating the shortened life of the battery when the temperature is above 77° F.:

Life Expectancy=50 months·(½)^{(x-77F)/15F},

where “x” is the temperature in Fahrenheit.

According to the embodiment shown in FIG. 4, central processing unit 410 samples temperature sensor 412 on a periodic basis determined by timer 414 and saves this temperature sample in non-volatile data store 416. On a less frequent periodic basis central processing unit 410 calculates an average temperature on the previously saved temperature samples and saves this calculation in data store 416. On a still less frequent periodic basis, central processing unit 410 averages all of the saved average temperature calculations and uses this overall average temperature to calculate the expected life of the battery using the equation above, where x is the overall average temperature. When the expected life of the battery approximates the current age of the battery, central processing unit 410 makes use of interface driver 408 to send a warning message through conductor 406 to power connector 404 and then across the power cable to an external device (e.g., an in-dash warning lamp, an aftermarket display, etc.). Alerts regarding the remaining life of battery 402 can be provided to the external device using other means (e.g., wireless communication, a separate data connection, etc.) than the power terminal 404.

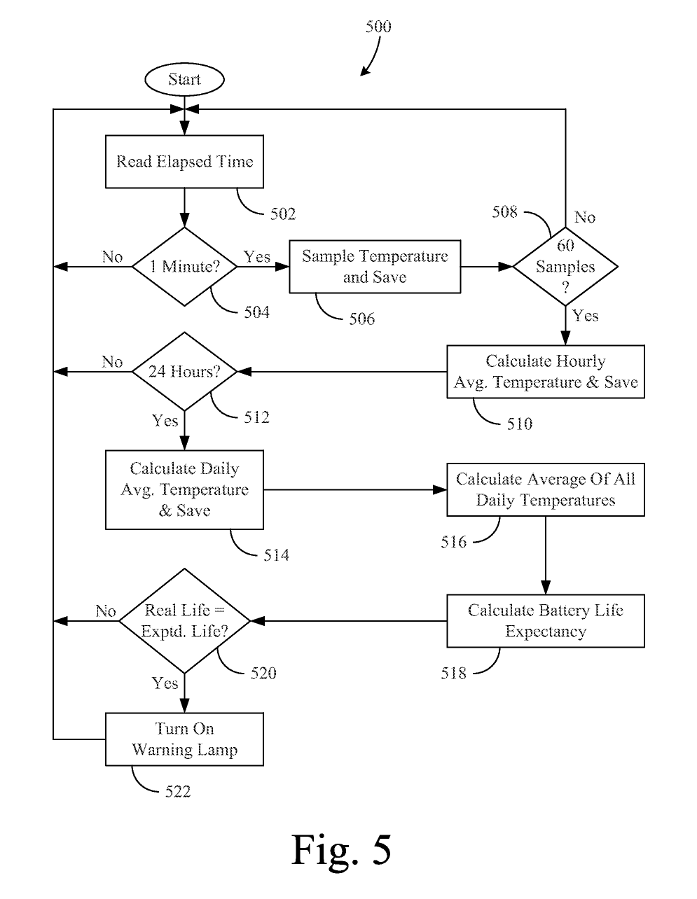

FIG. 5 is a flowchart summarizing a method 500 performed by computer system 400 (FIG. 4) in order to ascertain the expected life of a lead-acid battery and to notify the operator when the actual life of the battery approximates this expected life. In step 502, the elapsed time is read from timer 414. In step 504, if the elapsed time is one minute or more, program control proceeds to step 506. If not, program control returns to step 502. In step 506, the temperature is read from temperature sensor 412 and saved in data store 416. At step 508, a check is made to determine if 60 temperature samples have been taken and saved. If not, program control returns to step 502. If yes, then program control proceeds to step 510 where the 60 temperature samples are averaged and saved in data store 416. At step 512, a check is made to determine if 24 temperature calculations have been made and saved. If not, then program control returns to step 502. If yes, then program control proceeds to step 514 where the daily average operating temperature of the battery 402 is calculated from all of the saved hourly average temperature calculations. In step 516, an overall average operating temperature of the battery is calculated from the daily average temperatures. In step 518, the average operating temperature is used to calculate the expected life of the battery using this equation: Life Expectancy=50 months·(½)^{(x-77F)/15F}, where x is the overall average temperature. In step 520, a check is made to see if the actual life of the battery approximates the expected life of the battery. If not, program control returns to step 502. If yes, program control proceeds to step 522, which causes central processor 410 to issue a command via transceiver 408 to turn on a warning lamp for the vehicle operator (or to cause some other warning to be issued).

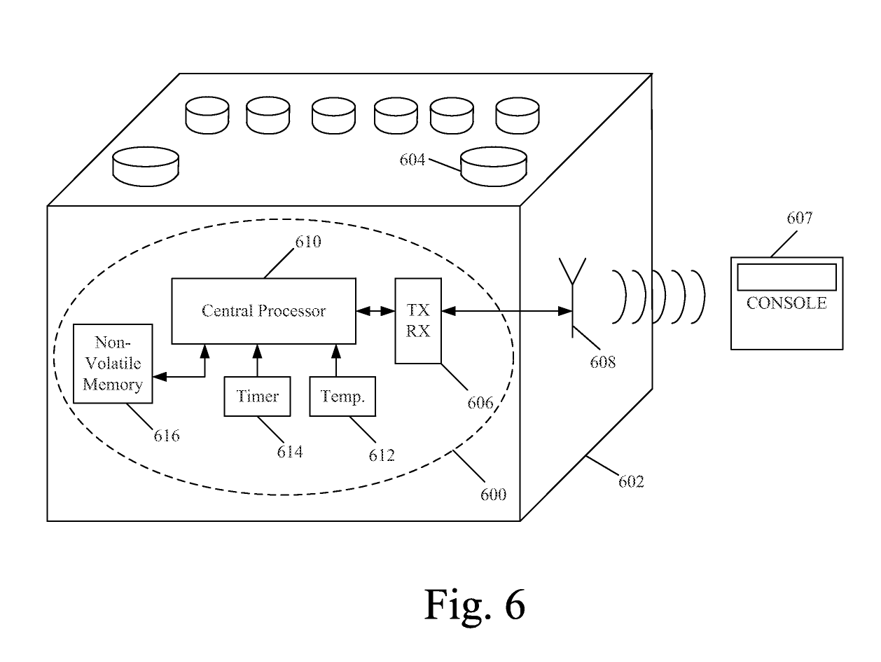

FIG. 6 is a block diagram of a computer system 600 according to another embodiment of the invention that is embedded inside a lead-acid battery 602. The computer system 600 calculates the remaining life of the battery based upon its operating temperatures, empirical data, and date of manufacture and makes this information available to a remote operator.

The lead-acid battery's lifespan is greatly affected by its operating temperature. Empirical data shows that, when compared to a battery operating at 25° C., the life of the battery is approximately 200% longer at −10° C., 180% longer at 0° C., 160% longer at 10° C., 140% longer at 15° C., 120% longer at 20° C., 15% shorter at 30° C., 25% shorter at 35° C., 50% shorter at 40° C. and 75% shorter at 50° C. Thus, empirical data reveals that the lifespan of lead-acid batteries is adversely affected by an increase in temperature. A battery operated at 32° F. (0° C.) will last 3 times longer than a battery operated at 100° F. (37.8° C.).

Empirical data also shows that, as of 2010, the current average life of the lead-acid starter battery in multiple northern locations in the United States is 59 months and in multiple southern locations in the United States is 47 months. Note that this empirical data is based on a post mortem analysis of 1496 batteries sampled between September and December of 2009 from ten locations across the nation. Because the average temperature in southern locations of the U.S. more closely approximates the 25° C. norm, the 47 month lifespan is used as the baseline for predicting the life of the battery in these particular embodiments.

It is the intent of this invention to make use of this empirical data in a battery monitoring system embedded in the battery. The invention will notify the driver, based upon the length of time in service and operational temperature measurements, that the battery is approaching its predicted end of life.

Computer system 600 includes a power terminal 604 and a transceiver 606. Transceiver 606 uses an antenna 608 to receive and transmit data between a central processor 610 and one or more external consoles 607 (e.g., an in-dash display near the vehicle operator, a smartphone, etc.). In one embodiment, transceiver 606 communicates using a low power wireless technology such as Bluetooth Low Energy, which is a feature of Bluetooth 4.0. Temperature sensor 612 measures the temperature inside the battery 602. Timer 614 measures the elapsed time between temperature samples. Non-volatile memory 616 stores the date of manufacture of the battery 602 and empirical data for the battery and provides this information to central processor 610 as needed.

Central processing unit 610 samples temperature sensor 612 on a periodic basis determined by timer 614 and saves this temperature sample in non-volatile data store 616. On a less frequent periodic basis central processing unit 610 calculates an average temperature on the previously saved temperature samples and saves this calculation in data store 616. On a still less frequent periodic basis central processing unit 610 averages all of the saved average temperature calculations and uses this overall average temperature to calculate the remaining life of the battery. When the remaining life of the battery approximates zero days (or falls below some other predetermined threshold), central processing unit 610 makes use of transceiver 606 to send a warning message via antenna 608 to an external device (e.g., the console display 607 near the vehicle operator).

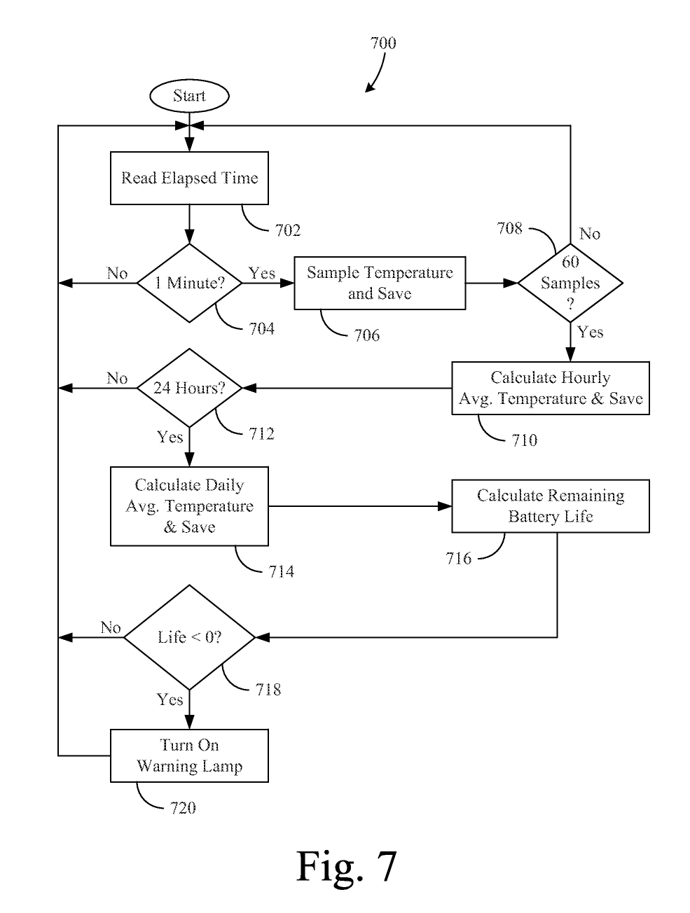

FIG. 7 is a flowchart summarizing a method 700 performed by computer system 600 (FIG. 6) in order to ascertain the remaining life of a lead-acid battery and to notify the operator when the battery should be replaced. In step 702, the elapsed time is read from timer 614. In step 704, if the elapsed time is one minute or more, program control proceeds to step 706. If not, program control returns to step 702. In step 706, the temperature is read from temperature sensor 612 and saved in data store 616. At step 708, a check is made to determine if 60 temperature samples have been taken and saved. If not, program control returns to step 702. If yes, then program control proceeds to step 710 where the 60 temperature samples are averaged and saved in data store 616. At step 712, a check is made to determine if 24 temperature calculations have been made and saved. If not, program control returns to step 702. If yes, program control proceeds to step 714 where the daily average operating temperature of the battery is calculated from all of the saved hourly average temperature calculations. In step 716, the average daily operating temperature is used to calculate the remaining life of the battery. The first time step 716 is executed, the manufactured date of the battery 602 is used to adjust the 47-month predicted life of a battery that is operated at 25° C. This adjusted age is then converted from months to days to render the remaining life of the battery in days. The second and all succeeding times step 716 is executed, the average daily temperature is used to calculate the operational day. If, for example, the average daily temperature was 100° C., then the 24 hour true length of a day is divided by 160% to derive the length of the operational day. (Note the operational life of a battery operated at 100 C is 160% longer than a battery operated at 250 C). The operational day, which is 0.625 in this example, is then subtracted from the remaining life of the battery. In step 718, a check is made to see if the remaining life of the battery has dropped below a predetermined threshold (e.g., zero operational days, etc.) that indicates the battery should be replaced. If not, program control returns to step 702. If yes, program control proceeds to step 720 where a battery life warning is provided to the console 607.

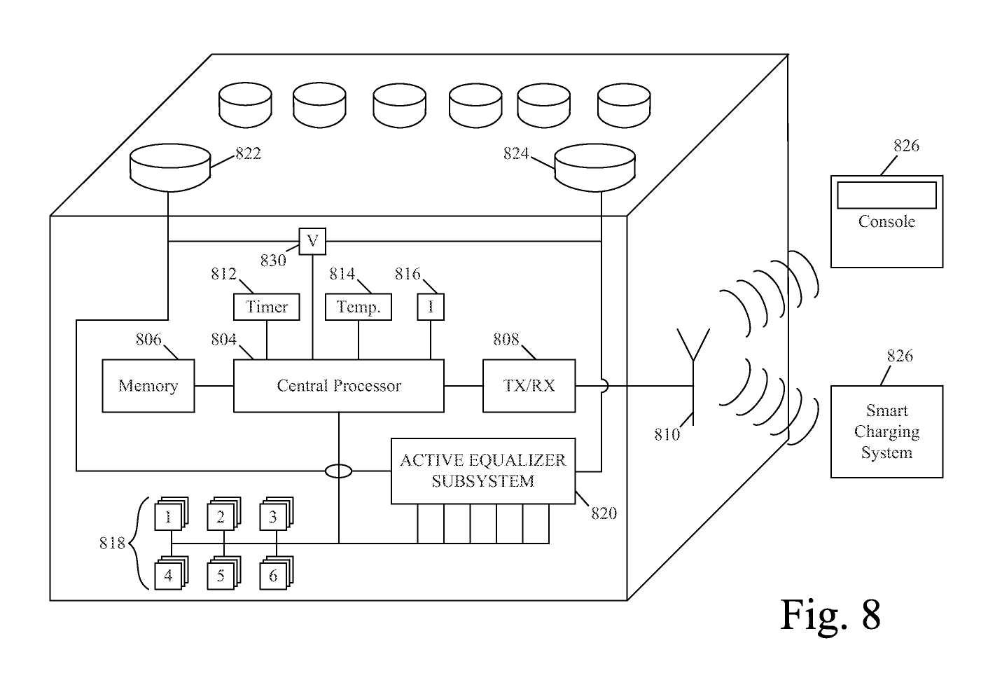

FIG. 8 is a block diagram of a computer system 800 embedded within a lead-acid battery 802. Computer system 800 includes the componentry necessary to implement any or all of the embodiments of the invention described previously herein, or to implement any of the embodiments described in the related battery applications incorporated herein by reference. Computer system 800 includes a central processor 804, non-volatile memory 806, and a transceiver 808, which in the present embodiment, is in communication with an antenna 810. Computer system 800 also includes a timer 812, a temperature sensor 814, a current sensor 816, and a plurality of sensors 818 that facilitate measuring operational characteristic(s) of the individual cells (6 cells in the present embodiment) of battery 802. Sensors 818 are shown representationally, but can include any or all of voltage sensors, temperature sensors, specific gravity sensors, electrolyte level sensors, pressure sensors, etc. such that the operational characteristics of the individual cells of battery 802 can be provided to central processor 804 and, optionally, external to the battery 802. Computer system 800 also includes an active equalizer subsystem 820, which is electrically coupled to the battery terminals 822 and 824 and implements the functions of the active equalizer subsystem 92 shown in FIG. 3. In the present embodiment, computer system 800 communicates wirelessly via antenna 810 (e.g., via low-power Bluetooth, etc.). However, computer system 800 can also be designed to communicate via one of its battery terminals 822, 824 or via some other wired data connection.

Computer system 800 advantageously extends the life of the battery 802, warns an operator using the battery 802 that the battery 802 is near the end of its life, and/or facilitates transmitting operational and charging characteristics of the battery 802, including its individual cells, outside of the battery 802 such as to a smart battery charging system 826. For example, computer system 800 can measure the operational characteristics of the battery 802 and its individual cells using any of its sensors and communicate this information external to the case of battery 802 via transceiver 808 and antenna 810 as described in U.S. patent application Ser. No. 12/321,310, which is incorporated by reference herein in its entirety.

Computer system 800 is also adapted to store battery-specific information (e.g., battery construction type, temperature dependent, optimal charge rate tables, manufacturing date and serial number, etc.) in its memory 806. Computer system 800 can retrieve this information and communicate it (along with any sensor information) external to the battery 802, for example to external smart charging system 826, as described in U.S. patent application Ser. No. 12/380,236, which is incorporated by reference herein in its entirety. The information provided to the smart charging system can be used by the smart charging system to determine the appropriate charging parameters for the battery 802.

Similarly, computer system 800 can also include the battery-specific information described above and algorithms for internally calculating a desired charge rate using the algorithms and battery-specific information stored in the memory 806, as well as sensor data provided by its sensors 812, 814, 816, 818, etc. The computer system 800 can then establish a connection with and request a desired charge rate from the external smart charging system 826 via the transceiver 808 and antenna 810. The computer system 800 can also generate charging (e.g., over-charging, temperature, etc.) warnings and communicate those warnings externally to the battery 802, such as to the smart charging system 826 and/or to an operator console 828. For example, if the level of the electrolyte does not completely cover all plates, no charging should be performed and the operator of the vehicle should be warned. As another example, if the specific gravity has dropped sufficiently, a carefully-monitored higher-than-normal equalization charge should be applied to the battery. As still another example, if the temperature of the battery spikes or the internal pressure of the battery becomes excessive, all charging should stop in order to prevent thermal runaway or excessive loss of electrolyte. Indeed, computer system 800 can employ any of the embodiments and methods described in U.S. patent application Ser. No. 12/454,454, which is incorporated by reference herein in its entirety. Computer system 800 is also adapted to detect the voltage between the battery terminals 822 and 824 via a voltage sensor 830. Additionally, memory 806 includes algorithms that the central processor 804 can execute to determine if the battery 802 is behaving erratically and near the end of its life. For example, the algorithms can use the data from voltage sensor 830 and other information, such as temperature data from temperature sensor 814 and time information from timer 814, to determine if the erratic behavior is occurring. In the case of an engine starter battery, the computer system 800 can determine if the state of charge of the battery 802 is low, if the battery 802 is producing erratic engine start times as compared to a temperature-indexed start time history, and/or if the battery 802 has an erratic initial start voltage (indicative of a starter motor engaging) as compared to a temperature-indexed initial start voltage history. If the battery 802 has a low state of charge and/or is behaving erratically as compared to historical readings, the computer system 800 can provide a warning outside the battery, via transceiver 808 and antenna 810, that the battery 802 is nearing the end of its life and needs replacement. Detailed algorithms for determining the health of the battery 802 are provided in U.S. patent application Ser. Nos. 13/272,905; 12/075,212;12/319,544; and 12/070,793 which are incorporated by reference herein in their entireties.

Finally, computer system 800 can selectively employ any or all of the embodiments described previously herein with respect to the preceding figures. For example, computer system 800 can employ passive and/or active cell balancing to extend the life of battery 802. Computer system 800 can also keep track of the remaining life of the battery 802 (e.g., based on empirical battery information, etc.) and warn of when battery 802 is nearing the end of its life by communicating with operator console 826. See, for example, U.S. patent application Ser. No. 12/655,275 and U.S. Provisional Patent Application Ser. Nos. 61/545,847 and 61/592,967, all of which are incorporated by reference herein in their entireties.

The description of particular embodiments of the present invention is now complete. Many of the described features may be substituted, altered or omitted without departing from the scope of the invention. Deviations from the particular embodiments shown will be apparent to those skilled in the art, particularly in view of the foregoing disclosure.

We claim:

1. In a battery including a case, a plurality of cells enclosed in said case, and a terminal electrically coupled to said plurality of cells, a method for balancing the charge of each of said plurality of cells, said method comprising:
generating sensor data using a sensor set disposed within said case, said sensor data including data indicative of a state of charge of each cell of said plurality of cells;
analyzing said sensor data using a processing unit disposed within said case to detect a charge imbalance between one or more of said cells; and
diverting charging current from said over-charged cell if at least one of said cells is over-charged compared to other ones of said cells, said step of diverting reducing the charge of said over-charged cell.

2. The method of claim 1, wherein said battery is a lead-acid battery.

3. The method of claim 1, wherein said step of diverting charging current from said over-charged cell includes diverting said charging current through a load.

4. The method of claim 3, wherein said load has a resistance of 100 Ohms.

5. The method of claim 1, wherein said step of analyzing said sensor data to detect a charge imbalance includes comparing a voltage associated with each cell of said plurality of cells with the average voltage of all of said plurality of cells.

6. The method of claim 5, wherein said step of diverting charging current occurs if at least one of said cells is over-charged compared to said average voltage of all of said plurality of cells by at least a predetermined amount.

7. The method of claim 6, wherein said predetermined amount is 0.01 Volts.

8. The method of claim 1, further comprising determining, using said processing unit, the life expectancy of said battery based on an average operating temperature over a defined amount of time.

9. The method of claim 8, wherein the life expectancy of said battery is determined by the formula (N)·(½)^{(x-77F)/15F}, where (N) represents the average life expectancy of a battery in months and x is said average operating temperature in Fahrenheit.

10. The method of claim 1, further comprising determining, using said processing unit, the remaining life expectancy of said battery based on an average operating temperature and empirical data associated with said battery.

11. The method of claim 1, further comprising:
receiving voltage data indicative of the output voltage on said terminal of said battery;
storing said voltage data in memory to create stored voltage data;
receiving new voltage data indicative of the output voltage on said terminal of said battery, said new voltage data including voltage data acquired during a time period from when a starter motor of a vehicle is energized by said battery and an engine of said vehicle starts and being indicative of an initial drop in said output voltage of said battery during a recent engine start;
retrieving said stored voltage data, said stored voltage data being indicative of initial drops in said output voltage of said battery during previous engine starts;
comparing said new voltage data to said stored voltage data using a processing unit;
determining whether said new voltage data differs from said stored voltage data by at least a predetermined amount; and
generating a notification signal when said new voltage data differs from said stored voltage data by at least said predetermined amount; and wherein said step of comparing said new voltage data to said stored voltage data includes comparing said initial drop in said output voltage of said battery during said recent engine start with at least one of said initial drops in said output voltage of said battery during previous engine starts.

12. A battery comprising:
a case;
a plurality of cells enclosed in said case;
a terminal electrically coupled to said plurality of cells;
a sensor set disposed within said case and operative to generate sensor data, said sensor data including data indicative of a state of charge of each cell of said plurality of cells; and
a processing unit disposed within said case, said processing unit being operative to analyze said sensor data to detect a charge imbalance between one or more of said plurality of cells, and
divert charging current from an over-charged cell if at least one of said cells is over-charged compared to other ones of said plurality of cells, said step of diverting reducing the charge of said over-charged cell.

13. The battery of claim 12, wherein said battery is a lead-acid battery.

14. The battery of claim 12, further comprising:
a load; and wherein said processing unit is operative to selectively divert said charging current through said load; and
said load has a resistance of 100 Ohms.

15. The battery of claim 12, wherein said processing unit is operative to analyze said sensor data to detect a charge imbalance by comparing a voltage associated with each cell of said plurality of cells with the average voltage of all of said plurality of cells.

16. The battery of claim 15, wherein said processing unit is operative to divert said charging current if at least one of said cells is over-charged by at least 0.01 Volts.

17. The battery of claim 12, wherein said processing unit is further operative to determine the life expectancy of said battery based on an average operating temperature over a defined amount of time.

18. The battery of claim 17, wherein said processing unit is further operative to determine the remaining life expectancy of said battery based on empirical data associated with said battery.

19. The battery of claim 12, further comprising:
a voltage sensor disposed inside said case and operative to provide voltage data indicative of an output voltage of said battery, said voltage data including voltage data acquired during a time period from when a starter motor is energized by said battery and an engine starts and being indicative of an initial drop in said output voltage of said battery;
memory operative to store data and code; and wherein
said processing unit is coupled to said memory and said voltage sensor and, responsive to said code, is operative to
receive said voltage data from said voltage sensor,
retrieve voltage data previously provided by said voltage sensor from said memory, said previously provided voltage data being indicative of initial drops in said output voltage of said battery during previous time periods when said starter motor is energized,
compare said voltage data from said voltage sensor to said voltage data previously provided by said voltage sensor,
determine whether said voltage data differs from said previously provided voltage data by at least a predetermined amount, and
generate a notification signal when said voltage data differs from said previously provided voltage data by at least said predetermined amount; and
said processing unit is operative to compare said initial drop in said output voltage of said battery with said initial drops in said output voltage of said battery during said previous time periods.

20. A battery comprising:
a case;
a plurality of cells enclosed in said case;
a terminal electrically coupled to said plurality of cells;
a sensor set disposed within said case and operative to generate sensor data, said sensor data including data indicative of a state of charge of each cell of said plurality of cells;
means for analyzing said sensor data to detect a charge imbalance between one or more of said plurality of cells, and
means for diverting charging current from an over-charged cell if at least one of said cells is over-charged compared to other ones of said plurality of cells, said step of diverting reducing the charge of said over-charged cell.
